(19) United States
(12) Patent Application Publication
(10) Pub. No.: US 2016/0169744 A1
(43) Pub. Date: Jun. 16, 2016

(54) DETECTOR SYSTEM PREVENTING FOOD BOIL OVER FOR STOVES

(71) Applicants: Gokhan APAYDIN, Gaziantep (TR); Sinan Hinislioglu, Gaziantep (TR)

(72) Inventors: Gokhan APAYDIN, Gaziantep (TR); Sinan Hinislioglu, Gaziantep (TR)

(73) Assignee: ZIRVE UNIVERSITESI, Gaziantep (TR)

(21) Appl. No.: 14/687,520

(22) Filed: Apr. 15, 2015

(30) Foreign Application Priority Data
Dec. 16, 2014 (TR) 2014/15249

(51) Int. Cl. G01J 5/00; F24C 3/12; F24C 7/08; G01J 5/10

(52) U.S. Cl. CPC G01J 5/0037; G01J 5/10; F24C 3/122; F24C 7/081

(57) ABSTRACT

A detector system is adapted on a stove in order to prevent boil over of food during cooking operations. The detector system has thermal camera(s) which detect when the food or liquid food substance cooked via heaters reach their boil over temperature, and a control unit which reduces the heating levels of heat adjusters or ceases heating when said boil over temperature is reached.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to a detector system adapted to stoves in order to prevent food boil over while cooking, comprising temperature detectors and intervening components.

2. Description of Related Art Including Information Disclosed Under 37 CFR 1.97 and 37 CFR 1.98.

During the process of cooking solid and liquid food substances such as food, milk etc., boil over, or in other words, overflow of liquid occurs for the liquid food substances that reach their boiling points. For instance, especially boil over of milk is a commonly encountered technical problem by housewives and cooks in the kitchens of homes and restaurants.

In the prior art stove systems, there is no system for preventing boil over of food. The temperature of the food containing liquid substances (water, milk, coffee, stews etc.) placed on the prior art stoves increase with the heat given by the stove. According to the amount of heat provided, the level of liquid increases and if this level is not checked properly, the food or liquid food boils over.

In the prior art stoves, in order to prevent boil over, the user needs to stay beside the stove and reduce the heating level of the stove when the food starts to boil. However, this situation varies according to the workload and the condition of the person. Usually, housewives or cooks who work busily can not wait beside the stove due to their tight schedule and high workload.

In the patent research made about the prior art, an application with no TR2012/12427 is encountered. In the abstract page of this application, a countertop stove structure is disclosed, which comprises a timer, a balance, and a boil over sensor.

In the application no. TR2014/03774, an application about a smart and safe countertop stove, comprising at least one LCD panel for control and monitoring of the systems found on a smart and safe countertop induction stoves and a smart and safe countertop electric stove and smart and safe gas stove, and at least one balance for scaling objects placed on it, at least one battery providing energy for illuminating the smart and safe countertop stove and the environment in case of a blackout, and a photoelectric boil over sensor that ends the heating operation by ceasing gas flow in case boil over occurs.

### BRIEF SUMMARY OF THE INVENTION

A purpose of the invention is to provide different technical characteristics than the prior art embodiments and bring innovation to the field.

A purpose of the invention is to provide a system that prevents liquid boil over during the process of cooking food and liquid food substances on a stove.

Another purpose of the invention is to determine the boil over temperature by means of a temperature sensitive camera to be positioned preferably on the aspirator over the stove. In this way, when the boil over temperature is reached, stove heating levels can be reduced or heating can be ceased by means of the control system.

Another purpose of the invention is to prevent possible home and work accidents and thus provide work safety by preventing food and liquid boil over on stoves.

Another purpose of the invention is to eliminate food and material waste by means of preventing food and liquid boil over on stoves.

Another purpose of the invention is to prevent the stove environment from getting dirty by means of preventing food and liquid boil over on stoves, and thus eliminate the risk of damage on the surrounding materials and tools due to liquid boil over.

### BRIEF DESCRIPTION OF THE SEVERAL VIEWS OF THE DRAWINGS

FIG. 1 is a schematic representative view of the system preventing food boil over, adapted on a representative stove and a representative aspirator.

### REFERENCE NUMBERS

100—Stove
101—Heaters
102—Heat adjusters
103—Aspirator
200—Detector system
201—Control unit
202—Thermal camera
203—Data transmitter

### DETAILED DESCRIPTION OF THE INVENTION

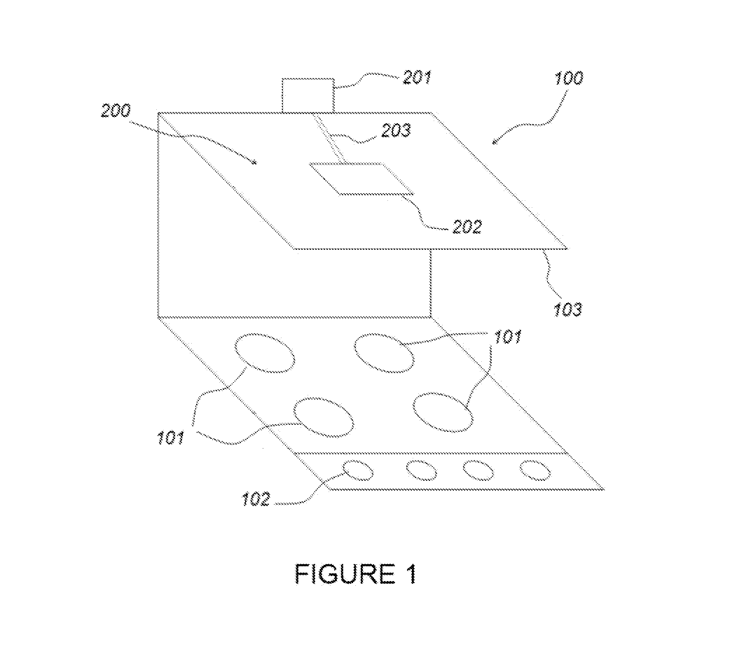

In FIG. 1, a schematic representative view of the general structure is shown together with a detector system (200) adapted on a stove (100) to prevent food boil over during cooking operation. Due to its innovation characteristic, the invention comprises thermal camera(s) (202), which detect when the food or liquid food cooked via the heaters (101) reach their boil over temperature, and a control unit (201), which reduces the heat levels or turns off the heat adjusters (102) when said boil over temperature is reached. Moreover, the invention also comprises data transmitter (203) components, which provide transmission of the data gathered via said thermal camera(s) (202) to the control unit (201).

The way of operation of the detector system (200) is as follows: When the food container starts to get heated by means of the heaters (101) found on the stove (100), temperature changes above the stove (100) are monitored with the thermal camera(s) (202), which is/are preferably positioned at the aspirator (103) part. When the temperature reaches a previously determined value, the control unit (201) adjusts the heating levels through the heat adjusters (102). In this way, food boil over is prevented by controlling the heaters (101). While thermal camera(s) (202) can be preferably adapted on the aspirator (103), it/they can also be positioned at any other area above the stove (100).

1. A detector system adapted on a stove in order to prevent boil over of food during cooking operations, characterized in that it comprises thermal camera(s), which detect when the food or liquid food substance cooked via heaters reach their boil over temperature, and a control unit which reduces the heating levels of heat adjusters or ceases heating when said boil over temperature is reached.

2. A detector system according to claim 1, characterized in that it comprises data transmitter means for providing transmission of the data gathered via said thermal camera(s) to the control unit.

3. A detector system according to claim 1, characterized in that it comprises a thermal camera positioned on the aspirator configured on said stove.
